(19) United States
(12) Patent Application Publication
(10) Pub. No.: US 2013/0226728 A1
(43) Pub. Date: Aug. 29, 2013

(54) Methods and Systems for Personalized Message Delivery

(71) Applicant: Bruno Oghittu, Marolles en Brie (FR)

(72) Inventor: Bruno Oghittu, Marolles en Brie (FR)

(21) Appl. No.: 13/781,674

(22) Filed: Feb. 28, 2013

Related U.S. Application Data
(60) Provisional application No. 61/604,912, filed on Feb. 29, 2012.

(51) Int. Cl. G06Q 30/06

(52) U.S. Cl. CPC G06Q 30/0621
USPC 705/26.5

(57) ABSTRACT

Methods for personalized message delivery are disclosed. In one embodiment, the method comprising the steps of receiving a personalized electronic message, associating the personalized electronic message with a retrieval code, receiving an order for an item corresponding to the personalized electronic message, and sending the retrieval code to a recipient of the ordered item, such that the retrieval code arrives contemporaneously with the ordered item. A notification message may be sent to the sender once the personalized message is received by the recipient.

### CROSS-REFERENCE TO RELATED APPLICATIONS

This application claims priority to U.S. Provisional Application No. 61/604,912, filed on Feb. 29, 2012, now pending, the disclosure of which is incorporated herein by reference.

### FIELD OF THE INVENTION

The invention relates to online order processing, for example, delivering personalized messages with an online order.

### BACKGROUND OF THE INVENTION

In years past, delivering gifts was a personal activity. Gifts were delivered in person and the giftor could relay a personal message. Gifts were also sent through the mail (or other delivery services) from the giftor (sender) to the recipient. Before sending the gift in a package, the sender could personalize the gift by, for example, wrapping and/or including a note. With the advent of online shopping, an increasing number of gifts purchased by senders are sent directly from online merchants to recipients. As such, a sender is unable to send a personalized message to a recipient where the recipient receives the message at the same as the recipient opens (i.e., receives) the gift.

Merchants have offered to send printed notes with gifts. However, these notes are restricted by size constraints and may not be suitable for some personalized messages. In addition, such notes are printed and lack a personal touch. Accordingly, there is a need for senders to be able to provide more personalized messages to recipients along with their gifts.

### BRIEF SUMMARY OF THE INVENTION

The present invention is directed to a method for personalized message delivery. The method may involve an electronic ordering system having a message recording interface. The method comprises the step of receiving a personalized electronic message from the message recording interface. The electronic message may include a video and the video may be incorporated into a template.

The personalized electronic message is associated with a retrieval code. The retrieval code may be a QR code. In one embodiment, the retrieval code is a Uniform Resource Locator associated with the personalized electronic message. In another embodiment, the retrieval code makes up at least a portion of a Uniform Resource Locator.

An order for an item corresponding to the personalized electronic message is received, and the retrieval code is sent to a recipient of the ordered item such that the retrieval code arrives contemporaneously with the ordered item. The retrieval code may be sent to a recipient by including the retrieval code with the ordered item. For example, the retrieval code may be printed and affixed to the ordered item.

In one embodiment, the method further comprises the step of receiving, from a requester, an electronic request to view the personalized electronic message. The electronic request may include the retrieval code. Based on the request, the personalized electronic message is provided to the requester. In another embodiment, the method further comprises the steps of receiving confirmation information from the requester and comparing the confirmation information with recipient information stored by the electronic ordering system. For example, the confirmation information might be the name of the recipient.

In one embodiment, the method further comprises the step of notifying a sender of the personalized electronic message when the personalized electronic message was provided to the requester.

In another embodiment of the present invention, an electronic request for a personalized electronic message access code is received from a merchant. A message access code is associated with the received electronic request, and the message access code is transmitted to the merchant.

A personalized electronic message is received from a sender, and the personalized electronic message from the sender is stored such that the personalized electronic message can be retrieved through use of the message access code.

An electronic request to view the personalized electronic message is received and the personalized electronic message is transmitted to the requester.

The invention may also be described as a method for personalized message delivery for an item ordered from an online ordering system. In one embodiment, an online ordering system is provided to a sender that allows the sender to order an item.

A message recording interface is provided to the sender. The message recording interface is configured to permit the sender to record a personalized message. The personalized message of the sender is received by way of the message recording interface, and the personalized message is associated with a unique code.

A code object is inserted into a package with the item. The code object includes the unique code. The package is shipped to a recipient. A delivery interface is provided to the recipient. For example, the message delivery interface is accessible by way of the code object. In one embodiment, the method further comprises the step of sending a notification message to the sender when the recipient has accessed the personalized message.

In another embodiment of the invention, a method is provided for enabling senders to provide personalized messages to recipients with the gift(s) sent by the sender, where an online ordering system is provided by a merchant to the customer (sender). The online ordering system has a checkout process wherein a message recording interface is presented to the customer. The customer uses the message recording interface to record/upload a personalized message (for the recipient) to the system. The personalized message may be, for example, an image, an audio recording, a video recording, or any other form of message.

The personalized message is received by the online merchant and associated with a unique code (for example, a Quick Response (“QR”) code). A tangible code object is inserted into the package and the package is shipped to the recipient. The personalized message is configured to be accessed by the recipient through the use of the QR code. In this way, when the package is received and opened by the recipient, the recipient scans the QR code (for example, through the use of a QR code reader app on a smartphone). A notification message may be sent to the sender once the personalized message is received by the recipient.

### DESCRIPTION OF THE DRAWINGS

For a fuller understanding of the nature and objects of the invention, reference should be made to the following detailed description taken in conjunction with the accompanying drawings, in which:

FIG. 1 is a diagram of a method in keeping with an embodiment of the present invention;

FIG. 2 is a flowchart depicting a method according to another embodiment of the present invention;

FIG. 3 is a diagram depicting a system according to an embodiment of the present invention;

FIG. 4 is a diagram depicting an Internet-based ordering system according to an embodiment of the present invention;

FIGS. 5-9 are diagrams depicting a graphical user interface (GUI) for personalized message delivery according to an embodiment of the present invention;

FIG. 10 is a diagram depicting Internet-based ordering system according to an embodiment of the present invention;

FIG. 11 is a flowchart depicting a method according to another embodiment of the present invention;

FIG. 12 is a flowchart depicting a method according to another embodiment of the present invention; and

FIG. 13 is a flowchart depicting a method according to another embodiment of the present invention.

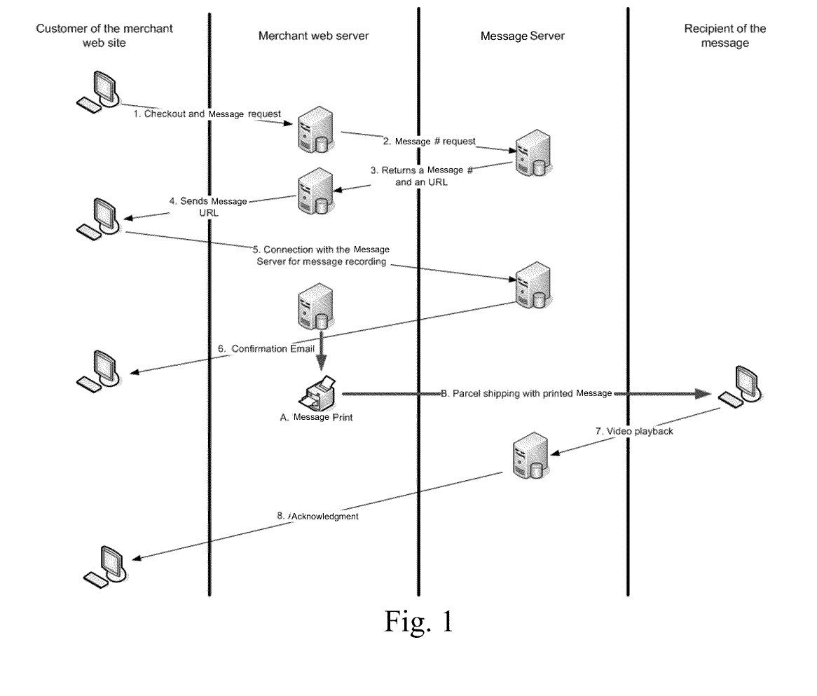

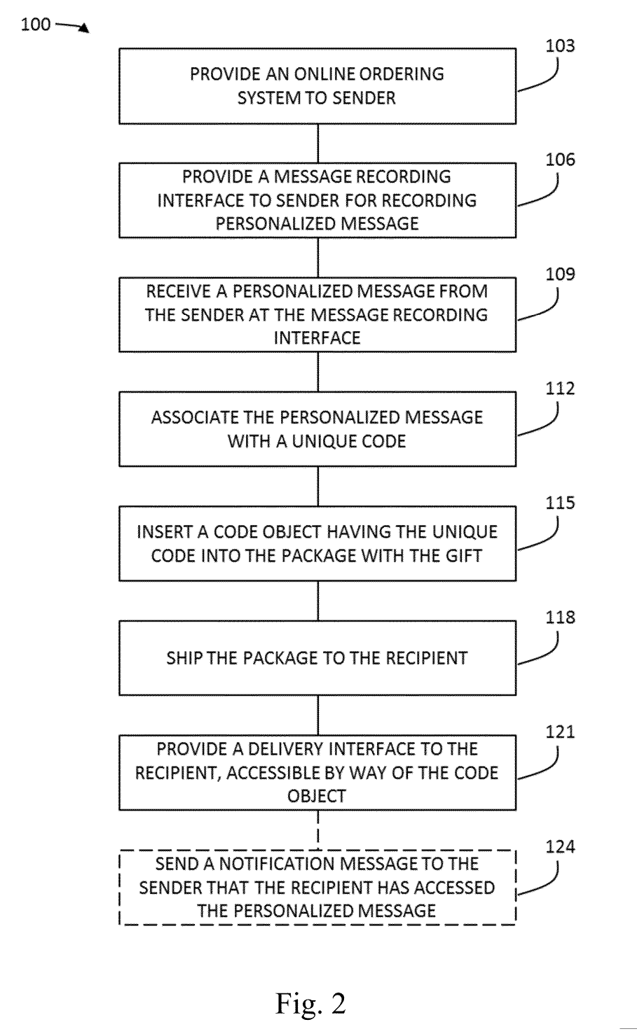

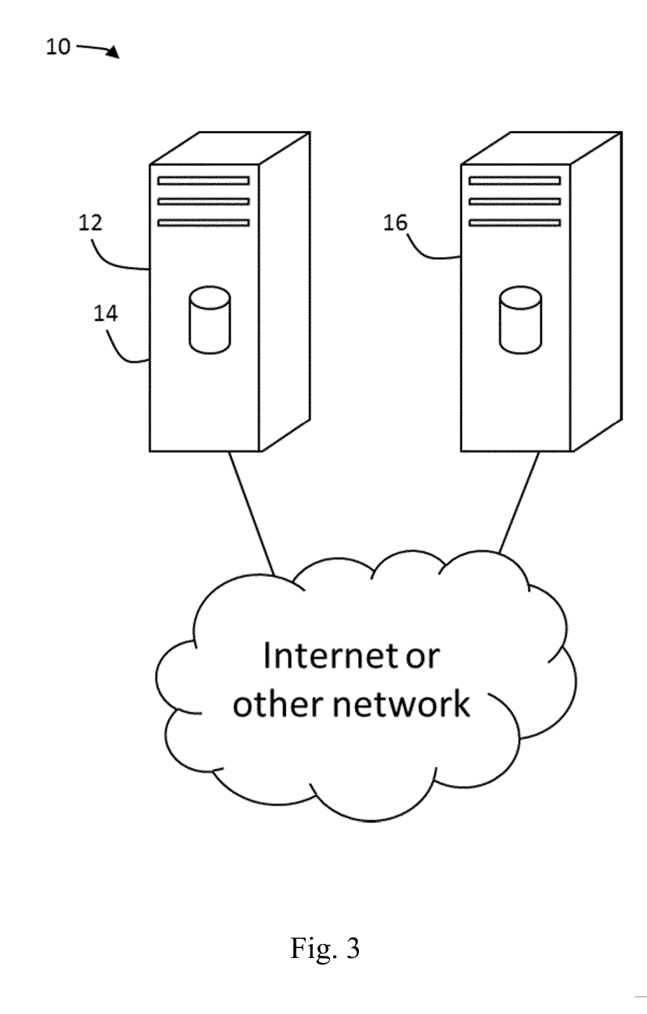

### DETAILED DESCRIPTION OF THE INVENTION

The present invention may be embodied as a method 100 for providing a sender the ability to include a personalized message with a gift sent to a recipient, where the receipt of the personalized message is synchronized to the time when the recipient receives the gift. For the purposes of the present disclosure, a sender (i.e., customer, giftor) purchases a gift from an online merchant, and the online merchant sends the gift in a package to the recipient designated by the sender. The method 100 comprises the online merchant providing 103 an online ordering system for use by the sender. The online ordering system is generally similar to those used in the art, where the customer is able to select one or more products to purchase and use a “checkout” process to procure the selected products.

In the present invention, the checkout process used in the method 100 further provides 106 the sender with a message recording interface where the sender can record the personalized message associated with the gift order to which the checkout applies. The personalized message may be an image, an audio recording, a video recording, or any other form of message. The personalized message may comprise more than one message format. In an embodiment, a message recording interface is provided 106 that allows the sender to use a webcam of the sender's computer to record a video message for the intended recipient of the gift. In another embodiment, the message recording interface enables the sender to upload a pre-made personalized message. The message recording interface may allow for more than one way for the sender to create and/or provide the personalized message.

The checkout process of the method 100 further comprises the step of receiving 109 the personalized message from the sender. The received 109 personalized message is associated 112 with a unique code. The code may be of any format convenient to the process. Codes may be unique in that the codes are only for one-time use. In another embodiment, codes may be re-used after a period of time (an expiration period).

Once the checkout process is complete, the online merchant processes the order by, for example, retrieving the selected gift product from inventory and packaging the gift for shipment. When packaging the gift, a code object is inserted 115 into the package. The code object includes the code associated with the personalized message. In an exemplary embodiment, the code object is a placard with a Quick Response (“QR”) code printed thereon, the QR code representing the unique code associated with the personalized message. As such, when the QR code is scanned using a QR code reader of a device (for example, a smartphone), the device uses the QR code to retrieve the personalize message for display on the device. QR codes are two-dimensional bar codes known in the art, and QR code reader applications have become commonplace.

The code object may be inserted 115 in the package such that when the package is opened by the recipient, the code object is the first items seen by the recipient. The code object may further contain text such as “scan this code for a message from [Sender]” (the Sender's name being inserted). The code object may be affixed to, or printed on, the shipping invoice, receipt, or label. In another embodiment, the code object is part of the package (i.e., printed on the shipping container) or affixed to the exterior of the package.

The online merchant ships 118 the package to the recipient. Shipment may be accomplished in the ways commonly known for shipment of physical packages. No special timing is necessary for the present method 100 to function. The personalized message is located and configured such that use of the code object will cause the personalized message to be retrieved and displayed. As such, the method 100 of the present invention comprises the step of providing 121 a delivery interface accessible by the recipient by way of the code object. Once accessed by the recipient, the delivery interface presents the personalized message to the recipient (for example, sends the data for display on a smartphone of the recipient). The delivery interface may further allow the recipient to send a message back to the sender. In this way, the recipient may send a personalized message (a reply), for example, a thank you message back to the sender. The reply message may be text, audio, video, or any other suitable message format. The recipient may have the email address of the sender, or the delivery interface may provide the ability to send a message to the sender without the recipient having or using the sender's email address.

The method 100 may further comprise the step of sending 124 a notification message to the sender when the recipient has accessed the personalized message. In this way, the sender will know when the recipient has received the gift (in other words, opened the package and accessed the personalized message). The notification message can be sent 124 electronically (e.g. through e-mail or another electronic message), via phone, by mail, or otherwise.

Embodiments of the present invention may be provided to senders for no cost. In other embodiments, the ability to send personalized messages is provided at a price. The provided 103 online ordering system may present the sender with an option for selecting delivery of a personalized message. If the sender elects to send a personalized message, the fee for the services may be added to the total fee for the order.

While an embodiment of the method 100 has been described where the steps are performed by the merchant, it should be apparent that a service provider may perform steps of the process. In this manner, an existing online merchant may offer the new service of providing the above-described personalized message by using a service provider incorporated into the existing order processing method. The service provider may present any computer display screens to the sender using frames, or similar technologies, such that, from the sender's perspective, the service is seamlessly integrated into the merchant's ordering system.

For example, the present invention may be embodied as a system 10 for providing a sender's personalized message synchronized with the receipt of a gift by the recipient. The system 10 comprises one or more merchant servers 12 hosting a merchant's website 14. The merchant's website 14 may include, for example, the product catalog, the e-Commerce application (e.g., checkout, etc.), the order management system, etc. The system 10 further comprises a message delivery server 16 for provision of a message recording interface and a message delivery interface.

In this exemplary system 10, the merchant server(s) 12 are separate from the message delivery server(s) 16. After payment to the online merchant by the customer, the merchant server(s) 12 may send data the particular transaction to the message delivery server(s) 16. Such data may include a merchant ID, customer order number, customer e-mail, customer first name, and customer last name, etc. The data may be sent through the Internet or a local internet (network). The data may be secured or encrypted before transmission to the message delivery server(s) 16.

The message delivery server(s) 16 may respond to the merchant server(s) 12. The response may include a unique message identifier, a QR code, and one or more uniform resource locators (URLs). The QR code may represent one of the URLs. The URLs may include links to websites for the recording and viewing of a personalized message. After receiving the reply, the merchant server(s) 12 may print documents to be placed with the gift in the package to be delivered. The documents may include information that is required by the recipient to view the personalized message. The merchant server(s) 12 may send a URL to the customer to create the personalized message. The merchant server(s) 12 may send the URL as part of an order confirmation page and/or an e-mail to the customer.

The customer may connect to the message delivery server(s) 16 in order to record the personalized message. In an embodiment, the personalized message may be a video from the customer's computer or a video captured by the personalized message delivery server. The video may be captured through a webcam. The personalized message may be stored on servers maintained by the merchant, the service provider, or another party. For example, the personalized message may be stored on Youtube.com®. In this way, the personalized message may easily be converted into one or more formats that are accessible by devices such as computers, smartphones, tablets, etc.

When the customer completes the personalized message, the merchant server(s) 12 or the message delivery server(s) 16 may send a confirmation message to the customer. The message may contain a URL that allows the customer to alter the personalized message at any time before delivery.

The merchant packages and sends the gift to the recipient. The package includes a document (e.g., a dedicated flyer or another shipping document such as a delivery slip) having a URL to the personalized message, a QR code to access the personalized message, and/or instructions to access the personalized message. The instructions, URL, and/or QR code may be printed on a packing slip included with the item. The QR code may be configured such that the personalized message is viewed by scanning the QR code with a mobile device.

Further details will be apparent in an example workflow for personalized message creation as follows:

A customer navigates to a merchant website. The merchant website receives the customer's selected items and request to checkout. The merchant website allows the customer to proceed as a guest or by logging into the merchant website. By logging in, the customer may have access to additional features, such as stored purchase history, discounts, or saved billing information. During checkout, the merchant website provides an offer to the customer to include a personalized message with delivery of the selected items. The merchant website receives the customer's request for a personalized message. The merchant website may provide the customer with a link to a message delivery website. In an embodiment, the customer may automatically be directed to the message delivery website.

The message delivery website provides the customer with a number of options to create a personalized message. In an embodiment, the messaging website accepts input from a webcam, microphone, and/or keyboard. The message delivery website saves the personalized message and allows the customer to include additional text. The message delivery website may provide a confirmation page and tracking information to the customer, as well as the merchant.

The merchant may access order information through the merchant website or message delivery website. The merchant may use the order information to pack and ship the customer's items. For example, the merchant may print a sheet with a QR code and/or URL associated with the personalized message and package the sheet with the customer's item.

When the recipient receives and opens the package, the recipient uses the sheet (having the QR code and/or URL) to retrieve the personalized message. As such, the recipient can view and/or hear the personalized message while they receive the gift contained within the package.

Further details will be apparent in an example Internet-based ordering system and GUI for personalized message creation as follows:

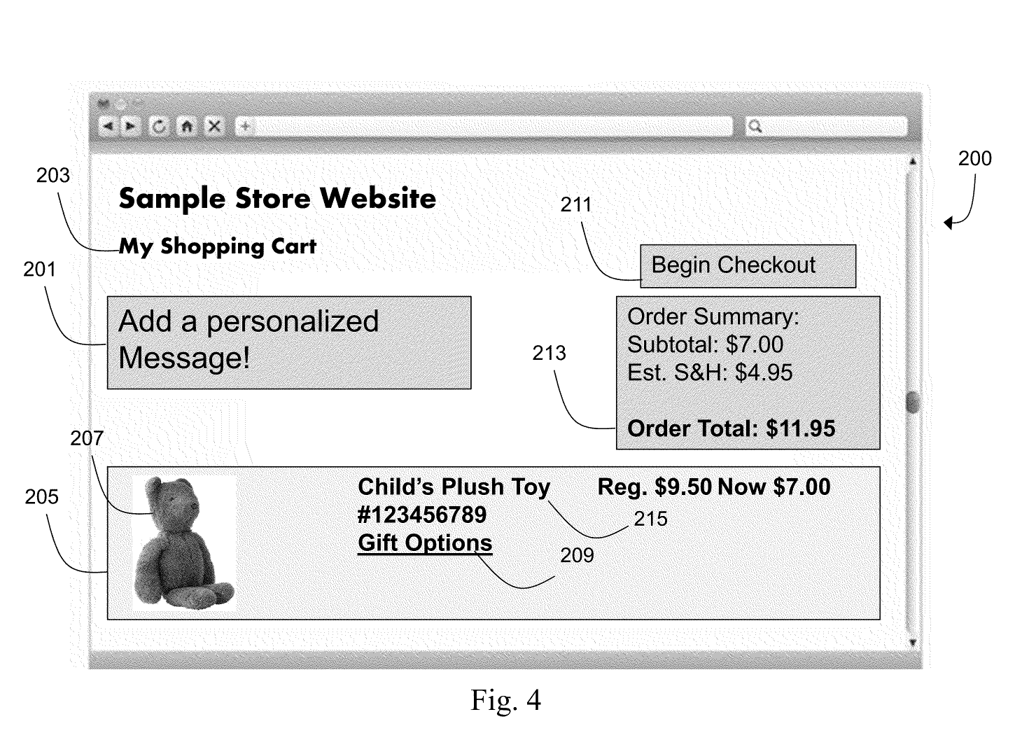

A customer navigates to a merchant website. After selecting products to purchase, the customer is presented with webpage 200, for example, as depicted in FIG. 4. This type of webpage is commonly referred to as a “shopping cart” or “shopping bag” and shows all of the items that a user has elected to purchase during their online shopping session. The shopping cart has a title 203 that may vary depending on each user. For example, the title 203 may be altered to include the name of a user if the user is a return shopper. The webpage 200 has a checkout button 211 that allows the user to begin the checkout process. This process involves entering user information, selecting payment type, and finally executing the order. The webpage may also include an order summary 213 that shows the combined costs of the items selected by the user during the online shopping session. Further details about the selected items may be listed in cart detail section 205. The cart detail section 205 may include images 207 of the item selected by the user as well as details about the items such as name 215 or gift options 209. The gift options 209 may simply be a text description, but may also link to additional information about the gift options available for that item. Webpage 200 also includes a button feature 201 that begins the personalized message delivery process. The button feature 201 may be present on other pages than the webpage 200, for example, after checkout or while selecting items to purchase.

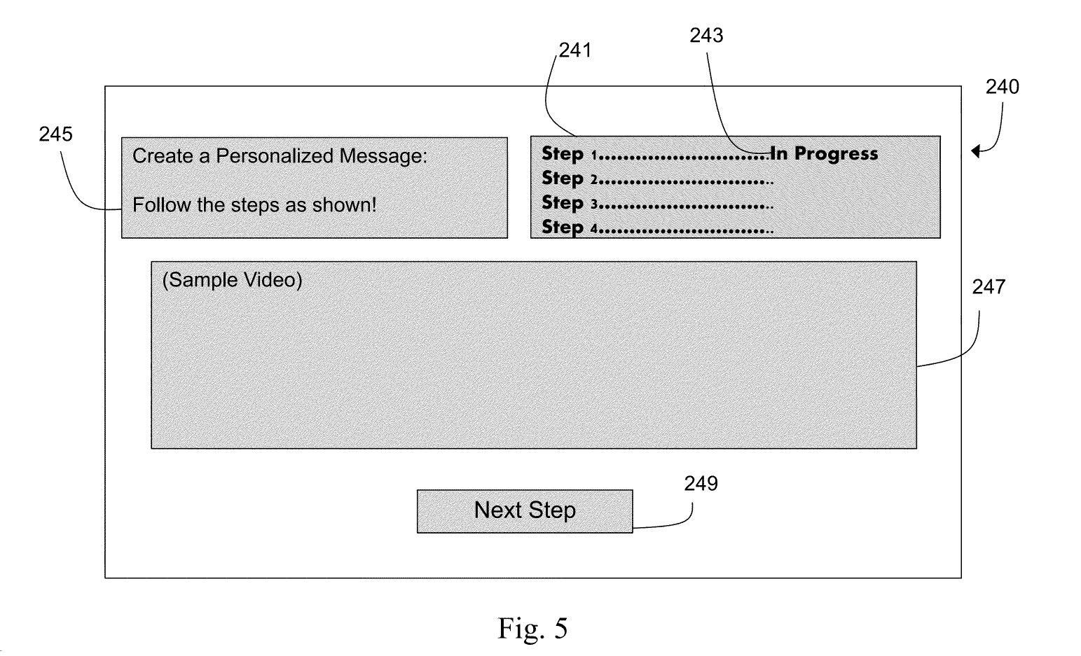

Upon activating the button feature 201, a graphical user interface (GUI) 240 may be displayed. One such example of a GUI can be seen in FIGS. 5-9. The GUI 240 may include a process indicator 241 that illustrates, using step indicator 243, what step the user is on in the personalized message process and how many other steps are remaining. For example, 3-4 step indicators 243 may be provided. The step indicator 243 may be graphically altered to indicate that the user is now on the indicated step.

GUI 240 may also include an information delivery panel 245. In panel 245 information is presented to the user in order to describe the personalized message delivery process. Panel 245 may display information via text, video, audio, or any other means known to one skilled in the art. GUI 240 may also include video panel 247. For example, video panel 247 may display an exemplary video to the user before the user records their own video. The GUI also includes next step button 249 that allows the user to advance to the next step provided that the user has completed all the requirements of the current step.

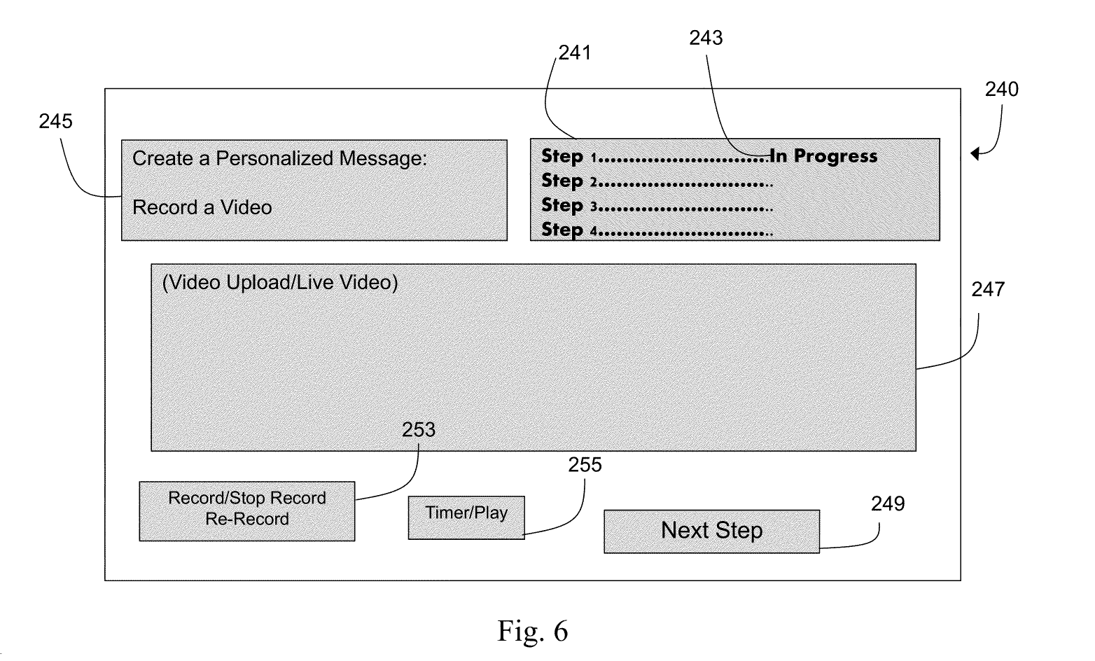

The GUI 240 may allow the user to record a personalized message as shown, for example, in FIG. 6. Here, video panel 247 is replaced with live video panel 251. The live video panel 251 displays information taken from the user's webcam or other video recording device. The live video may be in real time. The user may also be presented with a record button 253 that allows the user to begin recording from the video shown in video panel 251. During recording, the live video panel 251 may continue to display the video being recorded. Also during recording, the record button 253 may be replaced with a stop recording button. A timer 255 may be provided to provide the user with a visual representation of the length of the recorded video. The timer 255 may advance while the video is being recorded. The record button 253 may be replaced with a “try again” button after recording is stopped. In this way, the user can record and re-record their personalized greeting multiple times before deciding to proceed using the next step button 249.

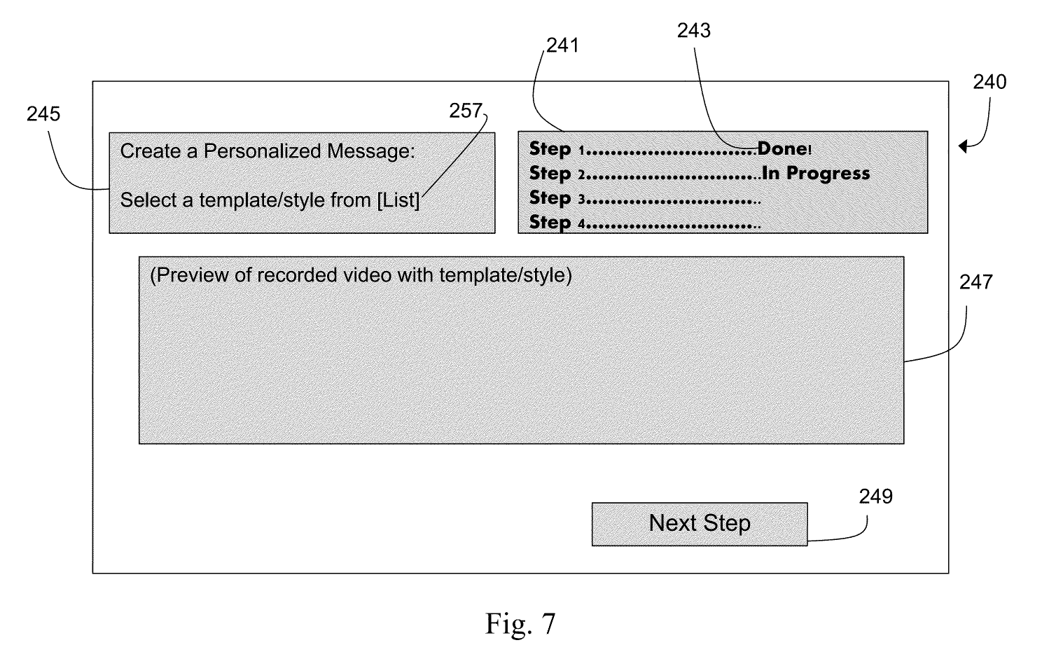

FIG. 7 illustrates another screen in the GUI 240 that allows the user to select a style or template to be applied to a recorded video. For example, the user may be given options of which styles 257 or templates to apply to the video. For example, the video itself may be altered, or the frame in which a video is inserted may be altered, or both.

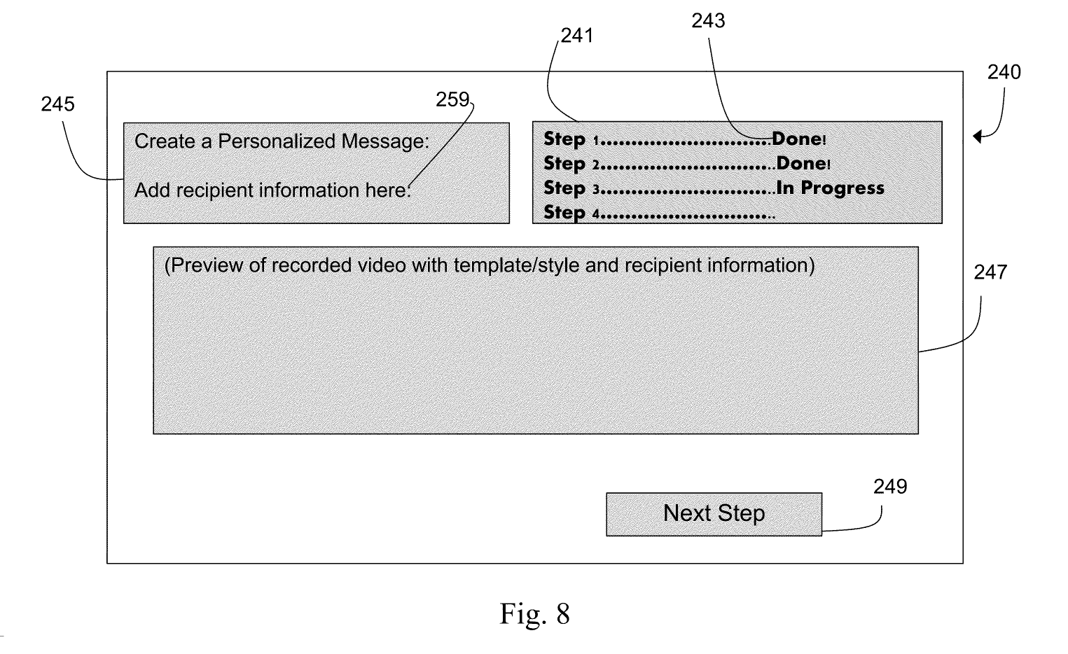

FIG. 8 illustrates a further screen in the GUI 240 that requests information 259 from a user in order to personalize the message and deliver the personalized message. For example the GUI 240 may require recipient information such as the name of the recipient or the recipient's e-mail address. Some of the information provided about the recipient may be used in order to restrict access to the final personalized message. For example, the recipient's last name may be required to be entered by the recipient in order to view the personalized message.

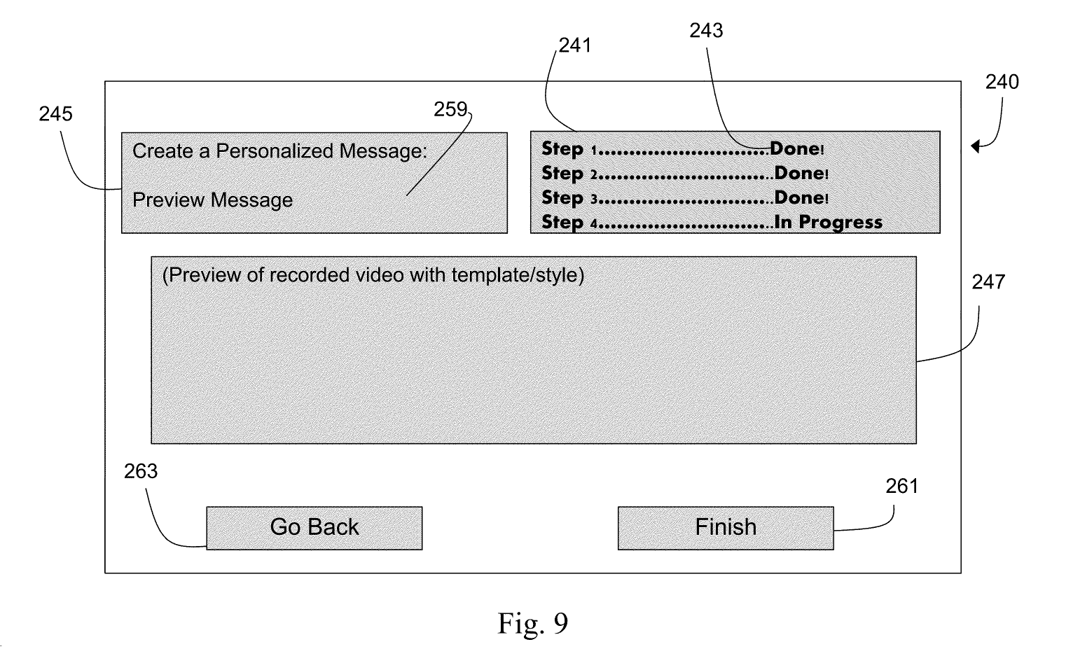

FIG. 9 illustrates a further screen in the GUI 240 that represents the final step before the personalized message is finalized. The user is given options to go back 263 or finish 261 the process.

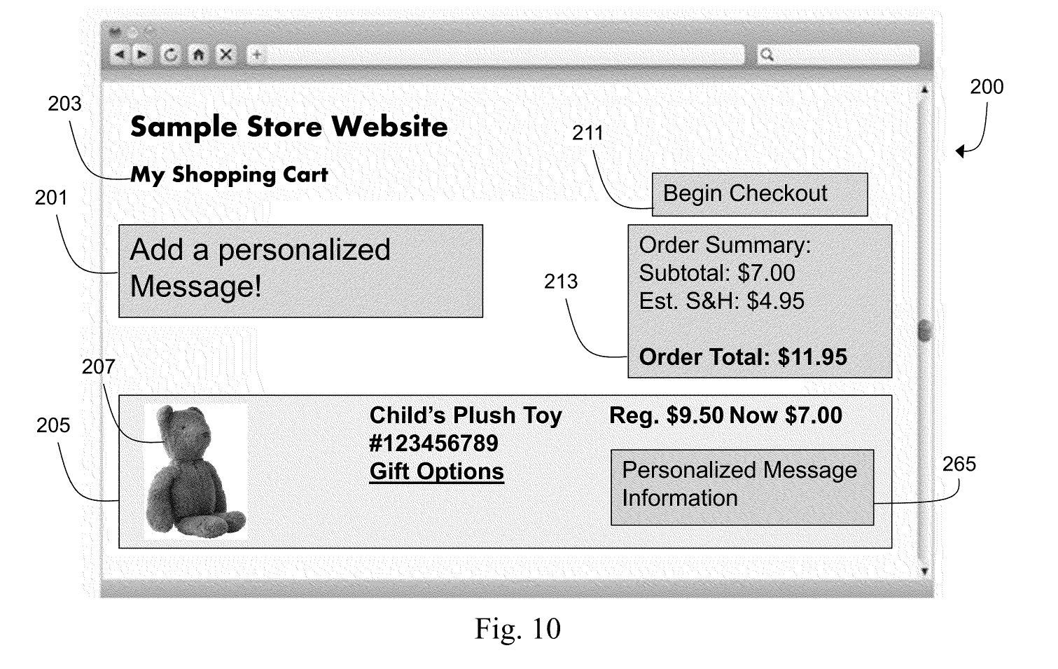

Once the personalized message is recorded and finalized, the shopping cart webpage 200 may be augmented to reflect the newly added personalized message information 265, for example, as shown in in FIG. 10.

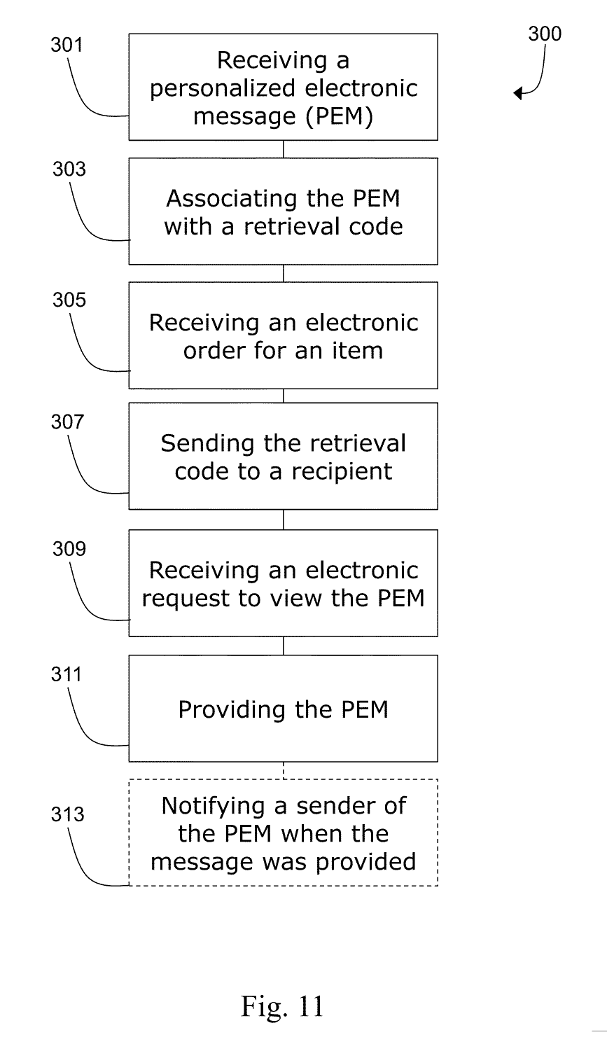

The present invention may be embodied as a method 300 for personalized message delivery using an Internet-based ordering system having a message recording interface as shown in FIG. 11. This embodiment includes the step of receiving 301 a personalized electronic message from the message recording interface. The personalized electronic message may be received 301 directly from a customer or indirectly. For example, the personalized electronic message may be received 301 through a third party, such as the merchant or another server.

The method 300 also includes the step of associating 303 the personalized electronic message with a retrieval code. The association step 303 may be performed in a database. For example, the retrieval code may be generated and associated 303 with a file that contains the personalized electronic message in a central database. The method 300 also includes the step of receiving an electronic order for an item from the Internet-based ordering system. The electronic order may contain specific information about the customer and the recipient.

The retrieval code is sent 307 to a recipient of the ordered item such that the retrieval code arrives contemporaneously with the ordered item. For the purposes of the present disclosure, the term contemporaneously does not require that the retrieval code arrives at the same time or through the same method as the ordered item. For example, the retrieval code may be sent physically with the item, or it may be electronically delivered before or after the item is physically delivered to the recipient. In one embodiment, the acknowledgment of delivery from a shipping company may act as a trigger to send 307 the retrieval code.

An electronic request to view the personalized electronic message is received 309. The request is received 309 through the use of the retrieval code. For example, the retrieval code may be a QR code configured to direct the recipient to a specific website providing 311 the personalized electronic message. The website may require additional information from the recipient (such as a name or e-mail address) before providing 311 the personalized electronic message. In another embodiment, the sender is notified 313 when the personalized electronic message is provided 311.

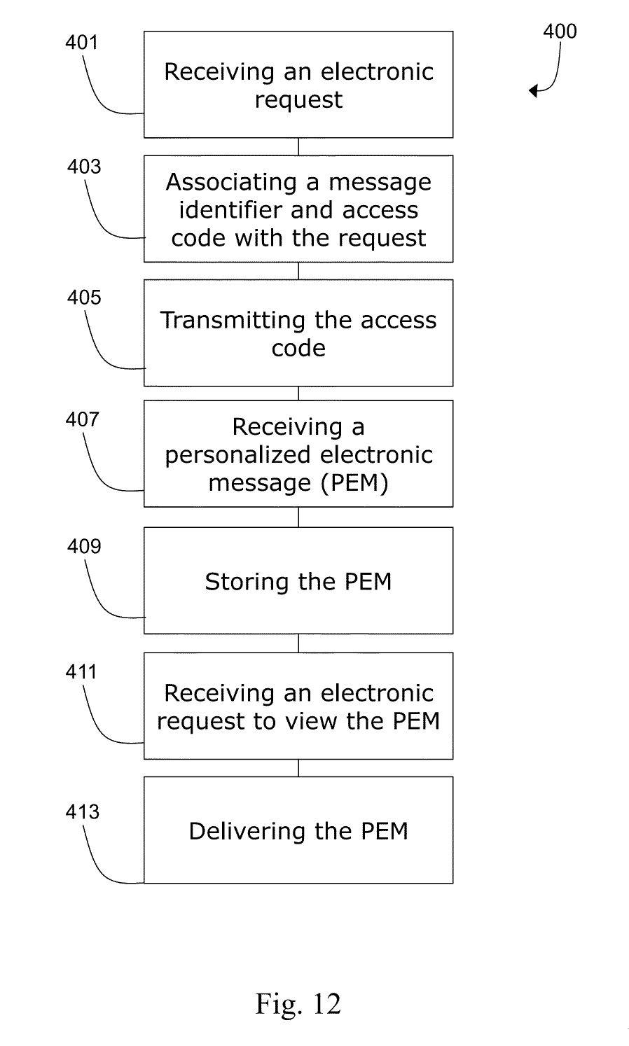

The present invention may also be embodied as a method 400 for personalized message delivery as shown in FIG. 12. In this method 400, the system providing personalized message delivery may be handled by two separate entities—the merchant and the message provider. The entities may utilize separate servers.

In method 400, an electronic request is received 401 from a merchant for a personal electronic message identifier. The request may be received 401 through the Internet or through a mobile phone network, or other electronic network as known to those skilled in the art.

A message access code is associated 403 with the received electronic request. For example, a URL may be associated 403 with the request in a database. In another embodiment, an identifier may also be generated and associated 403 with the request.

The message access code is transmitted to the merchant 405. For example, the message access code may be transmitted 405 directly to the customer or to an intermediary, such as a merchant or shipping processor. A personalized electronic message is received 407 from a sender. Again, the message may be received 407 directly from a customer or indirectly through a merchant or other third party.

The received personalized electronic message is stored 409 such that the personalized electronic message can be retrieved through use of the message access code. An electronic request to view the personal electronic message is received 411 and the personalized electronic message is delivered 413 to the requestor.

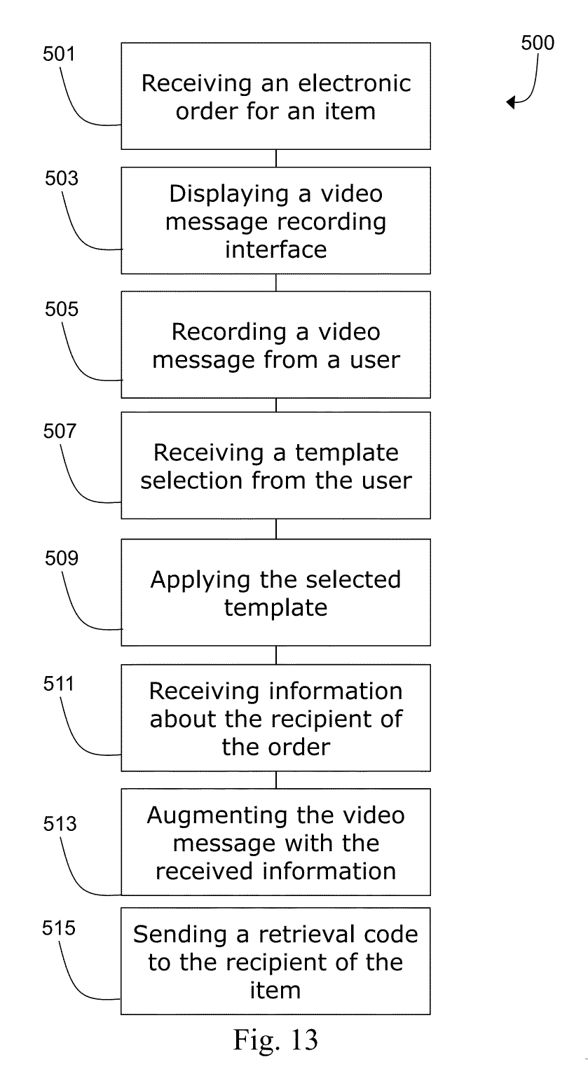

The present invention may also be embodied as a method 500 for personalized message delivery using an Internet-based ordering system having a video message recording interface as shown in FIG. 13.

In this method 500, an electronic order for an item from a user is received 501. For example the order may be received 501 through an e-commerce website or other online merchant. At some point during the purchase and order process, a video message recording interface is displayed 503 to a user. The video message recording interface may be similar to what was described above in FIGS. 5-9.

A video message from the user is recorded 505 electronically. The video message may be stored in a database and/or physically in an electronic storage device such as a hard drive. In some embodiments a style or template is selected by the user and the selection is received 507 and applied 509 to the recorded video message.

Information about the recipient of the electronic order is received 511. Here, the recipient refers to the final recipient of the order. For example, in one embodiment, the user may elect to ship the item to themselves, but then later distribute the item to the recipient. The information includes a retrieval code for allowing the recipient to retrieve the video message. In another embodiment, the video message may be augmented 513 with the received information about the recipient of the electronic order. For example, text may be added to the video, such as the recipient's name or the occasion for which the recipient will received the item. The retrieval code is sent 515 to the recipient of the ordered item such that the retrieval code arrives contemporaneously with the ordered item.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method for personalized message delivery using an electronic ordering system having a message recording interface, the method comprising the steps of:
receiving a personalized electronic message from the message recording interface;
associating the personalized electronic message with a retrieval code;
receiving, from the electronic ordering system, an order for an item corresponding to the personalized electronic message; and
sending the retrieval code to a recipient of the ordered item, such that the retrieval code arrives contemporaneously with the ordered item.

2. The method of claim 1, further comprising the steps of:
receiving, from a requester, an electronic request to view the personalized electronic message, the electronic request including the retrieval code; and
providing the personalized electronic message to the requester.

3. The method of claim 2, further comprising the steps of:
receiving confirmation information from the requester; and
comparing the confirmation information with recipient information stored by the electronic ordering system.

4. The method of claim 3, wherein the confirmation information is a name of the recipient.

5. The method of claim 1, wherein the electronic message includes a video.

6. The method of claim 5, wherein the video is incorporated into a template.

7. The method of claim 1, wherein the retrieval code is a QR code.

8. The method of claim 1, wherein the step of sending the retrieval code to a recipient is performed by including the retrieval code with the ordered item.

9. The method of claim 8, wherein the retrieval code is printed and affixed to the ordered item.

10. The method of claim 2, further comprising the step of notifying a sender of the personalized electronic message when the personalized electronic message was provided to the requester.

11. The method of claim 1, wherein the retrieval code is a Uniform Resource Locator associated with the personalized electronic message.

12. The method of claim 1, wherein the retrieval code makes up at least a portion of a Uniform Resource Locator.

13. A method for personalized message delivery, comprising the steps of:
receiving, from a merchant, an electronic request for a personalized electronic message access code;
associating a message access code with the received electronic request;
transmitting the message access code to the merchant;
receiving a personalized electronic message from a sender;
storing the personalized electronic message from the sender such that the personalized electronic message can be retrieved through use of the message access code;
receiving an electronic request to view the personalized electronic message; and
transmitting the personalized electronic message.

14. A method for personalized message delivery for an item ordered from an online ordering system, the method comprising the steps of:
providing the online ordering system to a sender for ordering the item;
providing a message recording interface to the sender, the message recording interface configured to permit the sender to record a personalized message;
receiving the personalized message of the sender by way of the message recording interface;
associating the received personalized message with a unique code;
inserting a code object into a package with the item, the code object including the unique code;
shipping the package to a recipient; and
providing a delivery interface to the recipient, the delivery interface accessible by way of the code object.

15. The method of claim 14, further comprising the step of sending a notification message to the sender when the recipient has accessed the personalized message.
